(19) United States
(12) Patent Application Publication
(10) Pub. No.: US 2008/0077423 A1
(43) Pub. Date: Mar. 27, 2008

(54) Systems, methods, and media for providing rights protected electronic records

(76) Inventors: Alan R. Gilmore, Holywood (GB); Fergus M. Wilson, Saintfield (GB); Marc Weddle, Federal Way, WA (US)

Correspondence Address: WILMERHALE/NEW YORK, 399 PARK AVENUE, NEW YORK, NY, 10022, US

(21) Appl. No.: 11/824,074

(22) Filed: Jun. 29, 2007

Related U.S. Application Data
(60) Provisional application No. 60/817,677, filed on Jun. 30, 2006.

(51) Int. Cl. G06Q 10/00; H04L 9/32

(52) U.S. Cl. 705/1

(57) ABSTRACT

Embodiments of the present invention provides systems, methods, and media for providing rights protected electronic documents. In some embodiments, in response to receiving a user's request for access to an electronic record, an ERMS may determine whether the user is authorized to access the electronic document, automatically apply digital rights management settings to the electronic document to form a protected electronic record, and transmit the protected electronic document to the user.

### CROSS-REFERENCE TO RELATED APPLICATIONS

This application claims the benefit of U.S. Provisional Patent Application No. 60/817,677, filed on Jun. 30, 2006, which is hereby incorporated by reference herein in its entirety.

### TECHNOLOGY AREA

The present invention generally relates to using Digital Rights Management protocols to ensure document integrity. More particularly, the present invention relates to Electronic Records Management Systems and applying Digital Rights Management protocols to electronic records that have been transmitted to an individual outside the ERMS.

### BACKGROUND

There is an increasing need for information to be accessible to distributed users within an organization. Electronic Records Management Systems (ERMS) are designed to provide this distributed access along with a degree of record integrity and control. Typically, records managers using an ERMS can ensure that electronic records (or documents) or collections of electronic records are accessible only to users within an organization who meet a specific profile. For example, a records manager can ensure that only human resources personnel of a particular profile have access to an organization's personnel records. The records manager can further ensure, for example, that only a given individual has the right to modify a personnel record. Using an ERMS, a records manager may also ensure that there is a log of access requests to a particular personnel record.

This degree of access control, however, normally only applies when the electronic record is within the ERMS. Once the record is transmitted outside of the ERMS, it loses the protections placed upon it. In the above example, if an authorized user sends via email a copy of a personnel record out of the organization, or takes a copy of a personnel record away on a CD, floppy disk, USB drive, or other removable storage device, the protections for that record are lost. Anyone accessing the copy of the personnel record will have the ability to copy, modify and further distribute the record. If the record is entered into another ERMS, the new ERMS will have no way of knowing what protections or controls were placed on the record in the first ERMS.

As used herein, access controls that travel with an electronic record are generally referred to as “persistent” controls. For electronic records, such as, for example, music files, movies, etc., persistence can be achieved with the use of Digital Rights Management (DRM) technology. When applied to an electronic music file (e.g., a Windows Media Audio (WMA) file, an Audio Interchange File Format (AIFF) file, etc.), DRM technology can provide restricted access to that music file such as limiting the number of times the file may be copied, the number and type of devices it may be played on, and the length of time the user may have access to the file. Conventionally, DRM controls have been applied to electronic music and film files and not to other types of electronic records.

Technologies such as Microsoft's Windows Rights Management Service (WRMS) provide a platform to support persistent controls on electronic records such as letters, memoranda, spreadsheets, presentations and the like. However, technologies like WRMS do not include a record control and retention function that can be provided by an ERMS. Therefore, there is a need to provide a way in which persistent controls can be mapped to the record lifecycle in an ERMS and also a way in which records with persistent controls, such as those provided by WRMS, may be imported into an ERMS without losing such persistent controls. Accordingly, it is desirable to provide systems, methods, and media that overcome these and other deficiencies of the prior art.

### SUMMARY OF THE INVENTION

In accordance with the present invention, systems, methods, and media for providing rights protected electronic records are provided.

Generally speaking, the present invention allows an ERMS to map WRMS or other persistent controls to an electronic record's lifecycle so that the access to or modification of an electronic record is controlled no matter where the electronic record may go, and to query and extract WRMS or other persistent control information from a DRM controlled record on importation into an ERMS.

According to various embodiments, a method for applying digital rights management settings to an electronic document can include storing the electronic document, receiving a request for access to the electronic document, automatically applying digital rights management settings to the electronic document to obtain a protected DRM document, and providing the protected DRM document in response to the request. In some embodiments, the electronic document can be stored in an electronic record management system.

In some embodiments, the method can further include determining which digital rights management settings to apply to the electronic document based one or more characteristics of the electronic document. The characteristics can include a folder with which the electronic document is associated, DRM settings with which the document was previously associated, a protective marking associated with the electronic document, and/or minimum digital rights management settings associated with the electronic rights management system.

In some embodiments, the DRM settings control at least one of: which users have access to the electronic document, viewing access to the electronic document, editing access to the electronic document, printing access to the electronic document, forwarding access to the electronic document, copying access to the electronic document, the expiration of access to the electronic document, the time of initial access to the electronic document, a time frame for accessing the electronic document, and an application that has access to the electronic document.

In some embodiments, the request can include a user rights profile, and the method can further include comparing the user rights profile with a record rights profile associated with the electronic document to determine whether the user is authorized to access the electronic document.

In some embodiments, the method can further include receiving the electronic document, and extracting digital rights management settings from the received electronic document.

In some embodiments, a system for applying digital rights management settings to an electronic document the system can include an electronic record management system that is configured to store the electronic document, receive a request for access to the electronic document, automatically apply digital rights management settings to the electronic document to obtain a protected DRM document, and provide the protected DRM document in response to the request.

In some embodiments, the electronic record management system can further be configured to determine which digital rights management settings to apply to the electronic document based on at least one characteristic of the electronic document. In some embodiments, the digital rights management settings can control which users have access to the electronic document, viewing access to the electronic document, editing access to the electronic document, printing access to the electronic document, forwarding access to the electronic document, copying access to the electronic document, the expiration of access to the electronic document, the time of initial access to the electronic document, a time frame for accessing the electronic document, and/or an application that has access to the electronic document.

In some embodiments, the electronic record management system can further be configured to receive a user rights profile with the request and compare the user rights profile with a record rights profile associated with the electronic document to determine whether the user is authorized to access the electronic document.

In some embodiments, the electronic record management system can further be configured to receive the electronic document and extract digital rights management settings from the received electronic document.

In some embodiments, a computer-readable medium is provided. The medium contains computer-executable instructions that, when executed by a processor, cause the processor to perform a method for applying digital rights management settings to an electronic document. The method can include storing the electronic document, receiving a request for access to the electronic document, automatically applying digital rights management settings to the electronic document to obtain a protected DRM document, and providing the protected DRM document in response to the request.

Thus, there has been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and description matter in which there is illustrated preferred embodiments of the invention.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 is a diagram illustrating the operations of an Electronic Records Management System in accordance with some embodiments of the present invention.

FIG. 2 is a flow diagram illustrating a method for providing persistent rights protection to electronic records in accordance with some embodiments of the present invention.

### DETAILED DESCRIPTION

According to various embodiments, methods, systems, and media are provided for applying Digital Rights Management (DRM) settings to electronic records Embodiments of the present invention are now described for purposes of illustration only. One skilled in the art will readily recognize from the discussion herein that alternative embodiments of the structures and methods illustrated herein may be employed without departing from the principles of the invention described herein.

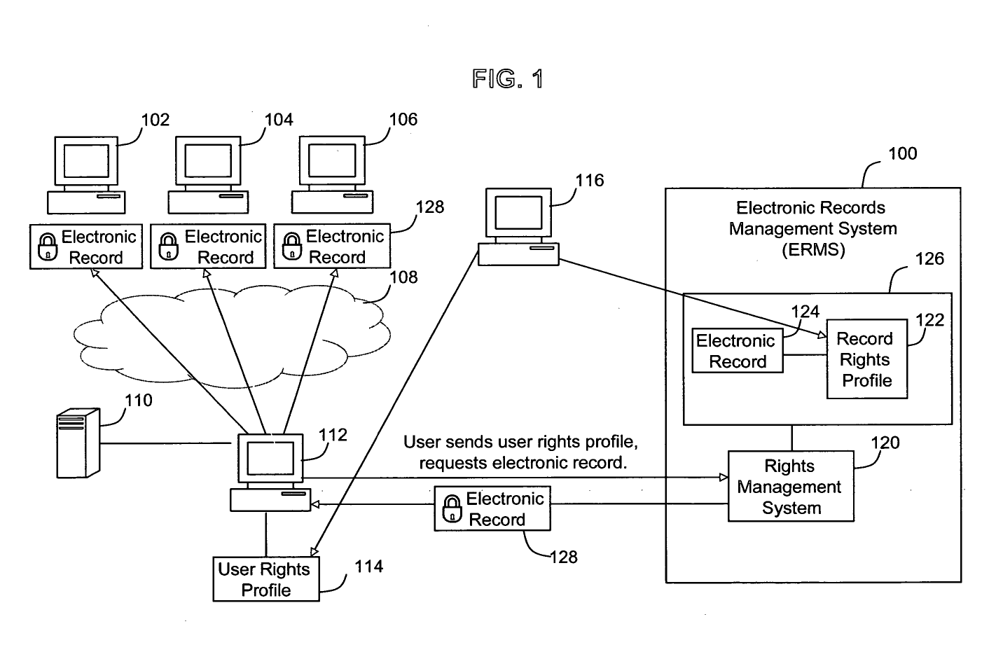

FIG. 1 is a diagram illustrating the operations of an Electronic Records Management System (ERMS) 100 in accordance with some embodiments of the present invention. ERMS 100 may include a rights management system 120 and a record repository 126. Record repository 126 may store a number of electronic records, such as electronic record 124 shown in FIG. 1. An electronic record (e.g., record 124) may be associated with a record rights profile (e.g., profile 122), which may also be stored in repository 126. Record repository 126 may be a file directory, a file server, a standard database, and the alike. Rights management system 120 may be connected to records repository 126. For example, rights management system 120 may communicate with records repository 126 over any suitable communications path. The communications path may be, for example, a proprietary connection, a universal serial bus (USB) connection, an IEEE 1394 connection (i.e., Firewire), a small computer systems interface (SCSI) connection, a serial connection, a parallel connection, an optical connection, an Ethernet connection, a radio-frequency (RF) link, an infrared (IR) link, or any other suitable wire-based or wireless communications path.

The record rights profile (e.g., profile 122) that is associated with an electronic record (e.g., record 124) may be predefined, for example, by ERMS 100, or may be created dynamically upon a user request for the electronic record. The record rights profile (e.g., profile 122) may be explicitly specified by a records manager 116 that is connected to ERMS 100, or implicitly specified based on the nature of a requesting user and/or the nature of the electronic record.

In some embodiments, a group of electronic records (e.g., records in a file folder) may be associated with a single rights profile. For example, record rights profiles (e.g. profile 122) may be configured at the folder level, meaning that all records (e.g., electronic record 124 and/or any other electronic records within records repository 126) stored within that folder may have the same record rights profile. Alternatively, record rights profiles may be configured at the individual record level. This may be desirable, for example, when certain records require special or unique protection rights. Rights profiles may also be configured such that particular contents are not rights protected at all. Organizations may use this configuration, for example, for all information that is publicly accessible, for information that has a particular protective marking, and/or for information that has been cleared and has gained a freedom-of-information status. This information may then be retrieved without any rights management applied, and may be shared without any persistent protection.

A user at computer (or computing device) 112 with a given user rights profile 114 may request electronic record 124 from ERMS 100. The user may be given a user rights profile (e.g., profile 114) that is predefined by ERMS 100. Alternatively, the user rights profile may be specified and given to the user by a records manager at computer (or computing device) 116. The user at computing device 112 or the records manager at computing device 116 may send user rights profile 114 to ERMS 100 when requesting electronic record 124.

In response to the request for electronic record 124 from ERMS 100, access to electronic record 124 may be granted by ERMS 100 according to existing access control and authentication mechanisms. Determining whether a user can access electronic record 124 may involve comparing the user's rights profile 114 (which may include access controls and permissions settings) against the record rights profile 122. Rights profiles (e.g., profiles 114 and 122) may be based on the electronic record's access control, protective markings, or record or record type within ERMS 100, or on specific business or organizational rules.

If the user that is requesting access to electronic record 124 does not have the appropriate authorization required for accessing the electronic record (e.g., user rights profile 114 does not allow the user to access electronic records with record rights profile 122), ERMS 100 may send a message indicating failure to the user. If the user does have the appropriate authorization, ERMS 100 may communicate this information to him and inform him that the electronic record requested is to be provided. Before the user is given access to electronic record 124, rights management system 120 may determine, based on user rights profile 114 and record rights profile 122, the persistent rights that should be applied to electronic record 124. Based upon this determination, rights management system 120 may apply appropriate DRM settings to electronic record 124 to create a protected electronic record 128. Protected electronic record 128, which includes the applied DRM settings, may then be transmitted to the user.

DRM settings applied to electronic record 124 may be based on user rights profile 114 and/or record rights profile 122. Because of this, profiles 12 and 20 may need to be pre-determined to be compatible with rights management system 120. In some embodiments, rights management system 120 can determine DRM settings to be applied to electronic record 124 based on one or more characteristics of the electronic record. For example, DRM setting can be determined based on the folder with which the electronic record is associated, DRM settings with which the electronic record was previously associated, and/or a protective marking associated with the electronic record.

As shown in FIG. 1, upon receiving protected electronic record 128, the user, using computing device 112, may save record 128 to a storage medium 110 (e.g., a removable storage medium such as a USB drive or a CD). The user using computing device 112 may also send record 128 to other computers or devices (e.g., computers 102, 104, 106), via email or any other suitable approach, using, for example, computer network 108. In both cases, DRM settings included in record 128 remain with record 128, thereby providing persistent protection of the record. Without directions from the retrieving user, electronic record 124 is automatically protected as it leaves the ERMS.

Rights management system 120 may apply persistent DRM settings to electronic record 124 to form protected electronic record 128 in any suitable manner. For example, rights management system 120 may encrypt electronic record 124 and apply DRM settings to record 124 in forming record 128. The DRM settings may be determined from rights profile information (e.g., profile 114 and/or 122). The DRM settings may specify who can access the electronic record, what that record can be used for (e.g., viewing, editing, printing, forwarding, copying, etc.), where that record may be accessed (e.g., only on certain computers, networks, etc.), when that record may be accessed (e.g., for a certain period of time, after a certain period of time, only one viewing, etc.), and how that record can be accessed (e.g., using certain applications, etc.). The DRM settings may, for example, specify how long the electronic record may remain outside the ERMS before access to the electronic record must be reauthorized by rights management system 120. Rights management system 120 may be implemented using, for example, the Windows Rights Management Service available from Microsoft Corporation.

To access information in protected electronic record 128, the user may need to use certain software or functionality that is compatible with rights management system 120. For example, when accessing a record containing a word processor file (e.g., such as a Microsoft Word document file), a word processor or word processing application with a suitable add-in or plug-in may be used to decrypt the file and ensure use only in accordance with the persistent DRM settings. Because not every type of content in the electronic record may be compatible with rights management system 120, ERMS 100 may change the type of content in the electronic record to make it compatible with rights management system 120. For example, if rights management system 120 is implemented using Windows Rights Management Service, a text file in an electronic record may be converted to a Microsoft Word file to make it compatible with the Windows Rights Management Service.

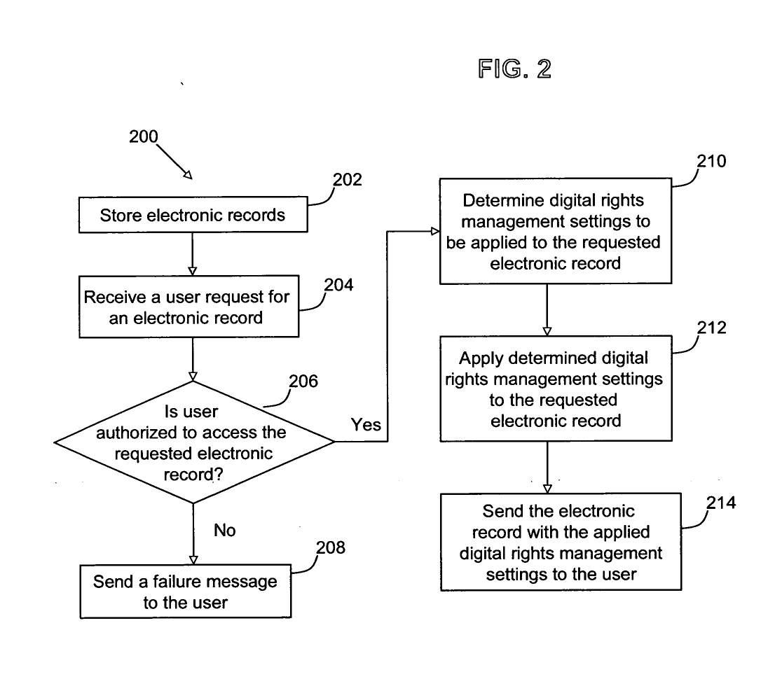

FIG. 2 is a flow diagram illustrating a method 200 in accordance with some embodiments of the present invention. Method 200 may be used by an ERMS (e.g., ERMS 100 in FIG. 1) to provide persistent rights protection to electronic records, and is described below in connection with FIG. 1. At step 202, ERMS 100 may store a number of electronic records. At step 204, ERMS 100 may receive a user request for an electronic record (e.g., record 124). The request may include a user rights profile (e.g., profile 114). At step 206, ERMS 100 may determine whether the user is authorized to access the requested electronic record. This determination may be based on the user rights profile in the request for the electronic file and a record rights profile (e.g., profile 122) associated with the requested electronic record. For example, ERMS 100 may compare the user rights profile with the records right profile to determine whether the user should be provided with access to the requested electronic record. If the user is not authorized, ERMS 100 may send a message to the user indicating the failure (step 208).

At step 210, if the user is authorized, ERMS 100 may determine the appropriate DRM settings to be applied to the requested electronic record. This determination may again be based on the user rights profile (e.g., profile 114) and/or the record rights profile (e.g., profile 122). At step 212, the determined DRM settings may be applied to the requested electronic record (e.g., record 124) to form a protected electronic record (e.g., record 128). At step 214, the protected electronic record (e.g., record 128) may be sent to the requesting user.

According to various embodiments, an ERMS may receive and import electronic records with DRM settings and maintain the imported records and settings. When importing a record, if an ERMS determines the existence of DRM settings on the record, it may extract the DRM settings from the record and classify the DRM settings into any suitable category, such as the following 5 categories:

1) Core—A core right may be one of the three basic rights that may be provided and enforced by Microsoft's Windows Rights Management Service: OWNER, EDIT, and VIEWRIGHTSDATA.

2) Persistent—A persistent right may be a right that is applied by the ERMS. After the corresponding record is imported to the ERMS, a persistent right may be reapplied to the record when a user requests the record. Persistent rights may be rights that are application-specific such as PRINT, SAVE, COPY, DELETE, and the like. They do not affect, and are not affected by, the record's importation into the ERMS in any way.

3) Mutable—Mutable rights may be superfluous and may be dropped on importation into the ERMS. Typically mutable rights might be those which no longer have meaning or value, or are potentially dangerous without further context if applied by the ERMS when the file is sent to a user. For example, imagine that a record, X, has to have a specific action Y performed on it before it is declared as a record within the ERMS. This specific action, Y, may not have any context outside of the ERMS and could potentially be removed from the record. Upon reintroduction into the ERMS, all relevant context could be lost, and, therefore, X may be declared as a record without action Y being performed.

4) Rejected—Rejected rights may be rights that are fundamentally incompatible with the existing rights management structure in the ERMS. In addition, a right may be categorized as rejected if the application of that right would create a RMS rights vulnerability.

5) Unknown—This label may be applied to rights that are unrecognized by the ERMS.

If the ERMS determines that a DRM setting falls into categories 1-3, the ERMS may apply the setting to the record (or ignore the setting in case of category 3) and store the record within the ERMS. If the ERMS determines that the DRM setting falls into category 4, the ERMS may be configured to perform a number of actions. For example, the ERMS may be configured to reject the addition of the new record—either entirely or at least until there is a rights profile associated with the record that falls into one of categories 1-3. Alternatively, the ERMS may be configured to simply remove the rejected rights.

If the ERMS determines that the DRM settings falls into category 5, that is, the rights profile is classed as “Unknown,” then the ERMS may create a “wrapper” (or metadata) for the record which allows it to be stored and indexed by the ERMS. Once the record is called upon by an application, the ERMS delivers the record to the requesting user with the wrapper. Prior to opening the record for the user, the application is presented with the wrapper, which may inform the application regarding what specific rights profile applies to the record.

Accordingly, systems, methods, and media for providing rights protected electronic records are provided.

Although the invention has been described and illustrated in the foregoing exemplary embodiments, it is understood that the present disclosure has been made only by way of example, and that numerous changes in the details of construction and combination and arrangement of processes and equipment may be made without departing from the spirit and scope of the invention.

It will also be understood that the detailed description herein may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

The system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on CD and/or DVD, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an object oriented and/or interpretive environment such as Java and transported to multiple destinations to various users.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

What is claimed is:

1. A method for applying digital rights management (DRM) settings to an electronic document, the method comprising:
storing the electronic document;
receiving a request for access to the electronic document;
automatically applying DRM settings to the electronic document to obtain a protected DRM document; and
providing the protected DRM document in response to the request.

2. The method of claim 1, wherein the electronic document is stored in an electronic record management system.

3. The method of claim 1, further comprising determining which digital rights management settings to apply to the electronic document based on at least one characteristic of the electronic document.

4. The method of claim 3, wherein the at least one characteristic includes a folder with which the electronic document is associated.

5. The method of claim 3, wherein the at least one characteristic includes digital rights management settings with which the document was previously associated.

6. The method of claim 3, wherein the at least one characteristic includes a protective marking associated with the electronic document.

7. The method of claim 3, wherein the at least one characteristic includes minimum digital rights management settings associated with the electronic rights management system.

8. The method of claim 1, wherein the digital rights management settings control at least one of: which users have access to the electronic document, viewing access to the electronic document, editing access to the electronic document, printing access to the electronic document, forwarding access to the electronic document, copying access to the electronic document, the expiration of access to the electronic document, the time of initial access to the electronic document, a time frame for accessing the electronic document, and an application that has access to the electronic document.

9. The method of claim 1, wherein the request includes a user rights profile and wherein the method further comprises comparing the user rights profile with a record rights profile associated with the electronic document to determine whether the user is authorized to access the electronic document.

10. The method of claim 1, further comprising:
receiving the electronic document; and
extracting digital rights management settings from the received electronic document.

11. A system for applying digital rights management (DRM) settings to an electronic document, the system comprising:
an electronic record management system that is configured to:
store the electronic document;
receive a request for access to the electronic document;
automatically apply DRM settings to the electronic document to obtain a DRM document; and
provide the protected DRM document in response to the request.

12. The system of claim 11, wherein the electronic record management system is further configured to determine which digital rights management settings to apply to the electronic document based on at least one characteristic of the electronic document.

13. The system of claim 11, wherein the digital rights management settings control at least one of: which users have access to the electronic document, viewing access to the electronic document, editing access to the electronic document, printing access to the electronic document, forwarding access to the electronic document, copying access to the electronic document, the expiration of access to the electronic document, the time of initial access to the electronic document, a time frame for accessing the electronic document, and an application that has access to the electronic document.

14. The system of claim 11, wherein the electronic record management system is further configured to:
receive a user rights profile with the request; and
compare the user rights profile with a record rights profile associated with the electronic document to determine whether the user is authorized to access the electronic document.

15. The system of claim 11, wherein the electronic record management system is further configured to:
receive the electronic document; and
extract digital rights management settings from the received electronic document.

16. A computer-readable medium containing computer-executable instructions that, when executed by a processor, cause the processor to perform a method for applying digital rights management (DRM) settings to an electronic document, the method comprising:
storing the electronic document;
receiving a request for access to the electronic document;
automatically applying DRM settings to the electronic document to obtain a protected DRM document; and
providing the protected DRM document in response to the request.
